(19) United States
(12) Patent Application Publication
(10) Pub. No.: US 2012/0300298 A1
(43) Pub. Date: Nov. 29, 2012

(54) 3D VISUAL DISPLAY SYSTEM AND METHOD

(76) Inventor: Xiao Lin Yu, Fairfax, VA (US)

(21) Appl. No.: 13/118,426

(22) Filed: May 29, 2011

(51) Int. Cl. G02B 27/22

(52) U.S. Cl. 359/478

(57) ABSTRACT

A three-dimensional (3D) display system is provided. The 3D display system includes at least one 3D display element containing a series of element bases, and each element base includes a plurality of light-emitting elements in a predetermined arrangement. The 3D display system also includes a moving mechanism coupled to the 3D display element for causing the 3D display element to move along a predetermined direction. Further, the 3D display system includes a controller configured to control respective light-emitting conditions of the plurality of light-emitting elements contained in each element base, when each element base is moving in the predetermined direction, to create dynamic pixels based on persistence of vision so as to form a layer of 2D display. The layers of 2D display corresponding to the series of element bases overlap together to form a 3D display.

### FIELD OF THE INVENTION

This application generally relates to display technologies and, more particularly, to visual systems with moving-pixel mechanisms.

### BACKGROUND

Current displays often are based on liquid crystal display (LCD) or plasma display panel (PDP) technologies, or based on high-definition projection technologies. The size and shape of an existing display screen is often limited by the current display technologies. More specifically, for three-dimensional (3D) displays, current 3D images are based on two-dimensional (2D) images with parallax between a viewer's left eye and right eye. Thus, the third dimension (z-axis) is a virtual dimension and the viewer needs to wear stereoscopic glasses in order to view the 3D images. Therefore, there is need for display technologies that provide more flexible display mechanisms, both in 2D and 3D display.

The disclosed methods and systems are directed to solve one or more problems set forth above and other problems.

### BRIEF SUMMARY OF THE DISCLOSURE

One aspect of the present disclosure includes a three-dimensional (3D) display system. The 3D display system includes at least one 3D display element containing a series of element bases, and each element base includes a plurality of light-emitting elements in a predetermined arrangement. The 3D display system also includes a moving mechanism coupled to the 3D display element for causing the 3D display element to move along a predetermined direction. Further, the 3D display system includes a controller configured to control respective light-emitting conditions of the plurality of light-emitting elements contained in each element base, when each element base is moving in the predetermined direction, to create dynamic pixels based on persistence of vision so as to form a layer of 2D display. The layers of 2D display corresponding to the series of element bases overlap together to form a 3D display.

Other aspects of the present disclosure can be understood by those skilled in the art in light of the description, the claims, and the drawings of the present disclosure.

### BRIEF DESCRIPTION OF THE DRAWINGS

FIGS. 1A-1B illustrate an exemplary display system consistent with the disclosed embodiments;

FIGS. 2A-2D illustrate forming the display with light-emitting elements consistent with the disclosed embodiments;

FIG. 3A illustrates an exemplary 2D display consistent with the disclosed embodiments;

FIG. 3B illustrates an exemplary multi-sector display consistent with the disclosed embodiments;

FIGS. 4A-4B illustrate an exemplary 3D display consistent with the disclosed embodiments;

FIGS. 4C-4D illustrate another exemplary display system consistent with the disclosed embodiments;

FIG. 5 illustrates an exemplary controller consistent with the disclosed embodiments;

FIGS. 6A-6B illustrates another exemplary display system consistent with the disclosed embodiments;

FIG. 7 illustrates an exemplary display system consistent with the disclosed embodiments;

FIG. 8 illustrates an exemplary fiber optic light system consistent with the disclosed embodiments;

FIG. 9A illustrates an exemplary configuration of an integrated element base consistent with the disclosed embodiments;

FIG. 9B illustrates another exemplary configuration of an integrated element base consistent with the disclosed embodiments;

FIGS. 10A-10C illustrate an exemplary circular magnetic levitation rotating structure consistent with the disclosed embodiments;

FIGS. 11A-11C illustrate exemplary configurations of an integrated element base consistent with the disclosed embodiments;

FIGS. 12A-12B illustrates exemplary configurations of driving mechanisms consistent with the disclosed embodiments;

FIG. 13 illustrates an exemplary power source generating structure consistent with the disclosed embodiments;

FIGS. 14A-14B illustrate an exemplary formation of 2D and 3D displays consistent with the disclosed embodiments;

FIGS. 15A-15B illustrate exemplary formations of 2D display consistent with the disclosed embodiments;

FIGS. 16A-16B illustrate another exemplary formation of 2D and 3D displays consistent with the disclosed embodiments;

FIGS. 17A-17B illustrate another exemplary formation of 2D and 3D displays consistent with the disclosed embodiments;

FIGS. 18A-18B illustrate another exemplary formation of 2D and 3D displays consistent with the disclosed embodiments;

FIGS. 19A-19B illustrate another exemplary formation of 2D and 3D displays consistent with the disclosed embodiments;

FIGS. 20A-20B illustrate another exemplary formation of 2D and 3D displays consistent with the disclosed embodiments;

FIGS. 21A-21B illustrate another exemplary formation of 2D and 3D displays consistent with the disclosed embodiments;

FIGS. 22A-22B illustrate another exemplary formation of 2D and 3D displays consistent with the disclosed embodiments;

FIGS. 23A-23B illustrate another exemplary formation of 2D and 3D displays consistent with the disclosed embodiments;

FIGS. 24A-24B illustrate another exemplary formation of 2D and 3D displays consistent with the disclosed embodiments;

FIGS. 25A-25B illustrate another exemplary formation of 2D and 3D displays consistent with the disclosed embodiments;

FIGS. 26A-26B illustrate another exemplary formation of 2D and 3D displays consistent with the disclosed embodiments;

FIGS. 27A-27B illustrate another exemplary formation of 2D and 3D displays consistent with the disclosed embodiments;

FIGS. 28A-28B illustrate another exemplary formation of 2D and 3D displays consistent with the disclosed embodiments;

FIGS. 29A-29B illustrate another exemplary formation of 2D and 3D displays consistent with the disclosed embodiments;

FIGS. 30A-30B illustrate another exemplary formation of 2D and 3D displays consistent with the disclosed embodiments;

FIGS. 31A-31 B illustrate another exemplary formation of 2D and 3D displays consistent with the disclosed embodiments;

FIGS. 32A-32B illustrate another exemplary formation of 2D and 3D displays consistent with the disclosed embodiments;

FIGS. 33A-33B illustrate another exemplary formation of 2D and 3D displays consistent with the disclosed embodiments;

FIG. 34 illustrates an exemplary display formation consistent with the disclosed embodiments;

FIG. 35 illustrates an exemplary display formation consistent with the disclosed embodiments; and

FIG. 36 illustrates an exemplary display formation consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

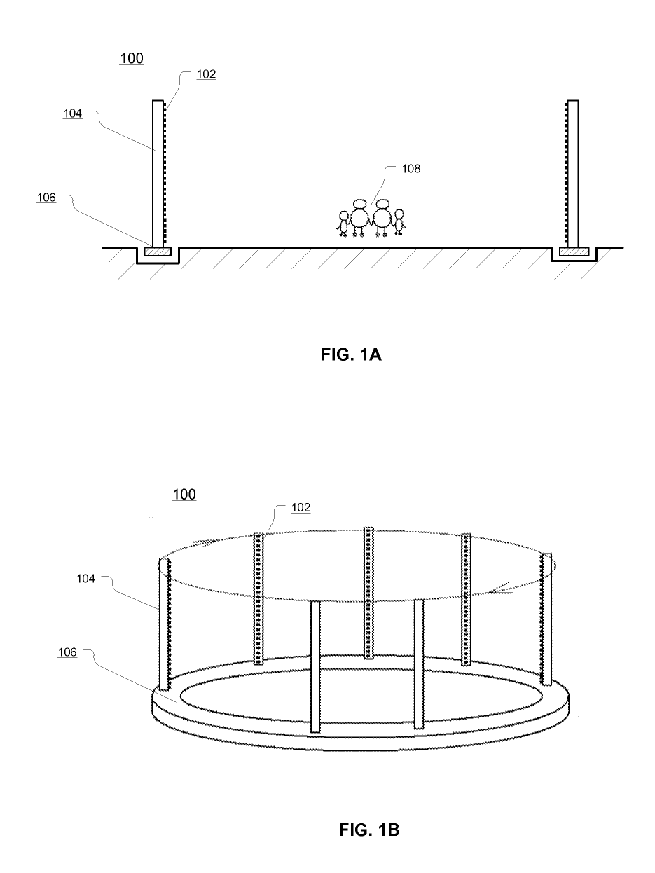

FIGS. 1A and 1B illustrate an exemplary display system 100 consistent with the disclosed embodiments. As shown in FIG. 1A, display system 100 includes a plurality of light-emitting elements 102, an element base 104, a circular rotating structure 106, and viewer(s) 108 (or view area 108). Other devices may also be included. For example, display system 100 may include a power source (not shown) for light-emitting elements 102, and may also include a driving mechanism (not shown) for driving circular rotating structure 106. In addition, display system 100 may include a controller (not shown) for controlling the various devices and/or display system 100.

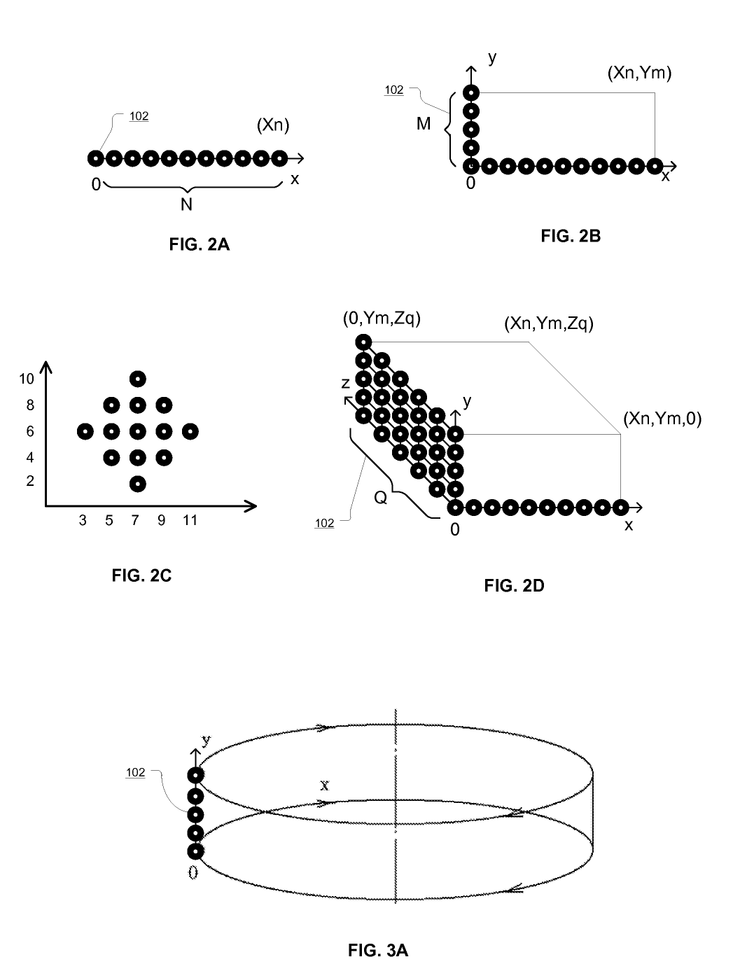

Light-emitting elements 102 are mounted on element base 104, which is further connected with circular rotating structure 106. During operation, circular rotating structure 106 may be rotated around a center of the circular rotating structure 106 to rotate element base 104 and light-emitting elements 102. Other moving mechanisms to move element base 104 in different directions may also be used. Further, individual light-emitting elements 102 may be controlled by the controller to emit light at a particular time and/or position while rotating with element base 104 so as to form a display. FIGS. 2A, 2B, 2C, and 2D illustrate forming the display with light-emitting elements 102.

As shown in FIG. 2A, when a single light-emitting element 102 moves along x-axis (i.e., a straight line) and emits light at a total N number of positions, because of the effect of persistence of vision of a viewer's eyes, the viewer can see a total N number of pixels X₀ to Xₙ in an one-dimension line along the x-axis. The distance between adjacent pixels may be determined based on what resolution is desired for the display, i.e., a shorter distance corresponds to a higher resolution, and the total length from X₀ to Xₙ is determined by the speed of the light-emitting element 102 and the time period for the persistence of vision, which is normally one twenty-fifth of a second.

Further, as shown in FIG. 2B, a column of light-emitting elements 102 move along x-axis, similar to FIG. 1A. The column of light-emitting elements 102 include a total of M number of light-emitting elements 102 aligned along the y-axis. Thus, a 2D array of pixels (Xₙ, Yₘ), n is from 0 to N, and m is from 0 to M, may be viewed by the viewer, and a 2D image may be displayed to the viewer. Alternatively, a single light-emitting element 102 may be used. The single light-emitting element 102 may be configured to move along the y-axis while moving around the x-axis, under the control of a controller. Because of the persistence of version, a 2D image may also be displayed similarly by dynamic pixels in the y-axis as well as in the x-axis. That is, the movement of the single light-emitting element along the y-axis simulates the column of light-emitting elements. In this disclosure, static pixels (i.e., actual light-emitting elements) or dynamic pixels may be used together or inter-exchangeably.

For example, as shown in FIG. 2C, to display a diamond image, the column of light-emitting elements 102 will be controlled when moving in the x-axis direction. At X=3, light-emitting element Y6 is turned on; at X=5, light-emitting elements Y4, Y6, and Y8 are turned on; at X=7,light-emitting elements Y2, Y4, Y6, Y8, and Y10 are turned on; at X=9, light-emitting elements Y4, Y6, and Y8 are turned on; and at X=11, light-emitting element Y6 is turned on. Because of the effect of persistence of vision, a 2D diamond is displayed.

Similarly, as shown in FIG. 2D, a total of Q columns of light-emitting elements 102 move along x-axis, and the Q columns are aligned along the z-axis. Thus, a total of Q number of 2D arrays of pixels are moved along the x-axis to form a 3D array of pixels (Xₙ, Yₘ, Z_{q}). Each column of light-emitting elements 102 form a layer of 2D display, as explained above, and the layers of 2D display overlap together to form the 3D array of pixels or the 3D image. Further, each column of light-emitting elements 102 or the 2D array of pixels may be transparent such that a 3D image may be displayed to the viewer.

Each individual light-emitting element 102 may be controlled separately to emit any appropriate type of light, such as a single light or a color (e.g., R, G, B) light. Further, light-emitting element 102 may include any appropriate type of light-emitting device, such as light emitting diode (LED) or other light source. Light-emitting element 102 may also include an optical fiber to guide light from the LED or other light source.

Alternatively, only one column of light-emitting elements 102 may be used and the one column of light-emitting elements 102 may be configured to move along the z-axis while moving around the x-axis, under the control of a controller. Because of the persistence of version, a 3D image may also be displayed similarly by dynamic pixels in the x-axis as well as in the z-axis. Further, the one column of light-emitting elements 102 may be simulated by a single light-emitting element moving along the y-axis.

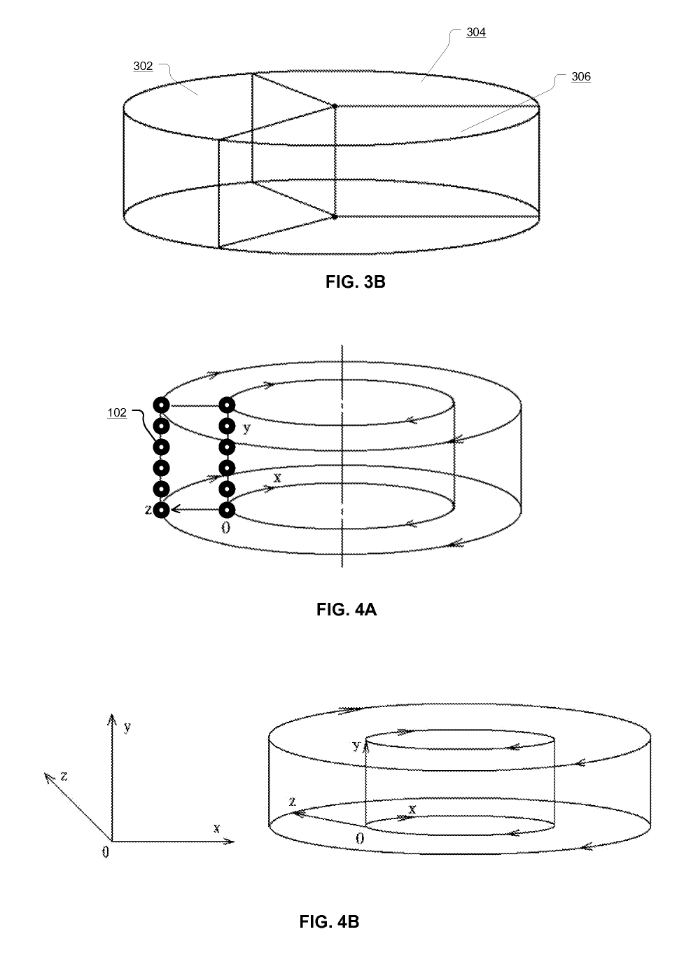

Returning to FIG. 1A, light-emitting elements 102 are aligned in any appropriate predetermined arrangement, such as one or more column in a shape of line, curve, or other shapes, on element base 104. Because element base 104 is rotated along a center by circular rotating structure 106, the column of light-emitting elements 102 also moves along a circle, as shown in FIG. 3A. When the column of light-emitting elements 102 are in a circular motion, a cylindrical 2D display plane is formed. This 360° circular 2D display plane can be used to display a single picture frame. That is, during operation, the controller in display system 100 controls the light-emitting elements 102 to emit light at certain level and/or color at certain positions on the 360° circular 2D display plane to form pixels of the single picture frame.

Thus, instead of displaying the picture using static pixels on traditional display devices, display system 100 displays the picture using dynamic pixels based on moving or rotating light-emitting elements 102. Although a circular moving direction is illustrated, any appropriate directions may be used. For example, the element bases may move along a straight line, a curve, or any other directions.

This 360 ° circular 2D display plane can also be used to display multiple picture frames, each being displayed at a portion of the 360 ° circular 2D display plane. As shown in FIG. 3B, a total of three picture frames are displayed. One picture is displayed on sector 302, one is displayed on sector 304, and one is displayed on sector 306. Similarly, a 3D display may also be displayed in multiple sectors.

However, a single column of light-emitting elements 102 may be insufficient to form the cylindrical 2D display plane due to the limited time period of persistence of vision. Thus, as shown in FIGS. 1A and 1B, a plurality of element bases 104 are provided. The number of element bases 104 may be determined based on the size of the 2D display plane, the period of persistence of vision, and/or viewer's viewing experience.

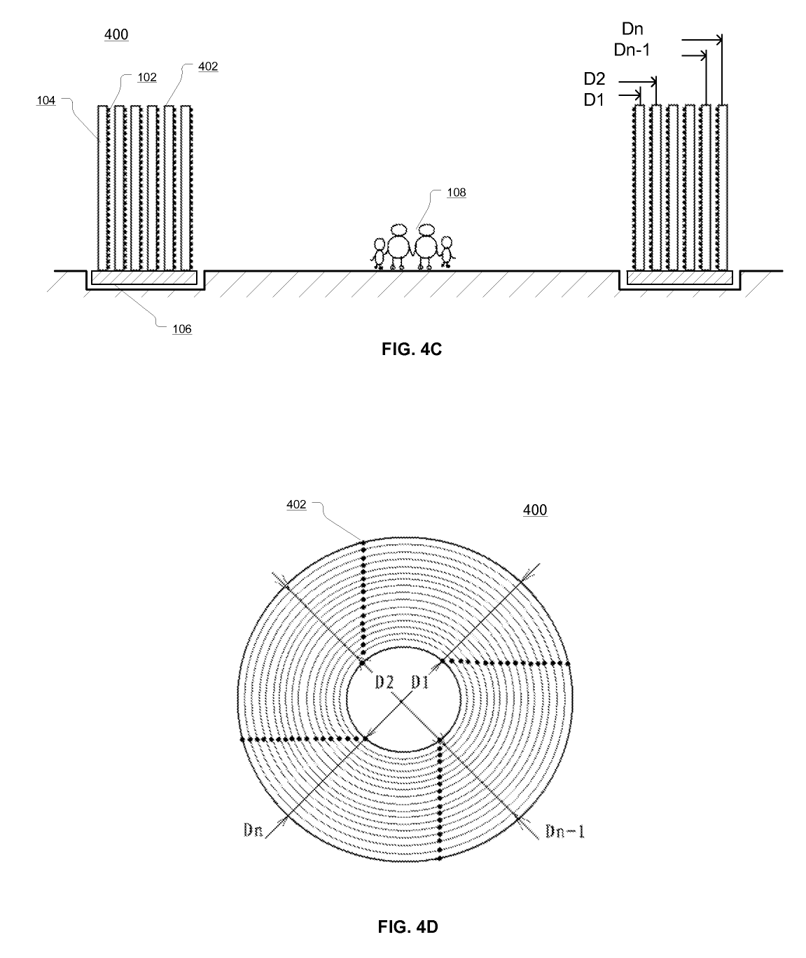

As explained above, columns of light-emitting elements may be arranged to move along a horizontal direction to form a flat 3D image display. Other shapes or forms of 3D image display can also be arranged. For example, as shown in FIG. 4A, a 2D array of light-emitting elements 102 are in a circular motion in the direction of the x-axis, and a cylindrical 3D display is thus formed. Other shapes such as sphere surface, semi-sphere surface, or other curve surface may also be used.

Similarly and alternatively, only one column of light-emitting elements may be used and the one column of light-emitting elements may be configured to move along the z-axis while moving around the x-axis, under the control of a controller. Because of the persistence of version, a 3D image may also be displayed similarly by dynamic pixels in the x-axis as well as in the z-axis. That is, the movement of the single column of light-emitting elements along the z-axis simulates the 2D array (or columns) of light-emitting elements. Further, the single column of light-emitting elements may be simulated by a single light-emitting element moving along the y-axis.

As shown in FIG. 4B, x-axis stands for the direction of the circular arc, y-axis stands for the display/screen height (e.g., the direction of the column of light-emitting elements 102), and z-axis stands for the 3D scene depth (e.g., the direction of the columns of light-emitting elements are arranged or the direction of a single column of light-emitting elements 102 moves to simulate the columns of light-emitting elements). The x-axis is the direction for moving or rotating the light-emitting elements 102 to form x-axis pixels at different time and locations based on the persistence of vision. The y-axis is the direction for a column of the light-emitting elements 102 to form y-axis pixels corresponding to the x-axis pixels and together to form a layer of the 3D image (i.e., a 2D display). The 3D scene depth is formed by a plurality of layers of the 3D image overlapped together in the z-axis such that a hollow cylinder space for forming the 3D image can be created. Thus, the 3D scene depth along the z-axis may be a real image and not a virtual image. In other words, the 3D image has a real third dimension instead of a virtual one in traditional display technologies.

Based on FIGS. 4A and 4B, FIG. 4C illustrates an exemplary 3D display system 400 consistent with the disclosed embodiments. As shown in

FIG. 4C, display system 400 includes a series of element bases 104, and each element base 104 includes a plurality of light-emitting elements 102 in a single column or multiple columns such that an array of light-emitting elements 102 is formed. This array of light-emitting elements 102, i.e., the series of element bases 104 with corresponding light-emitting elements 102, is also referred to as 3D display element 402. The element bases 104 may be made with transparent materials.

Further, display system 400 includes circular rotating structure 106 and viewer(s) or viewer area 108. Other devices may also be included. For example, display system 400 may include a power source (not shown) for light-emitting elements 102, and may also include a driving mechanism (not shown) for driving circular rotating structure 106. In addition, display system 400 may include a controller (not shown) for controlling the various devices and/or display system 400.

Further, for a 3D display element 402, because each element base 104 is rotated around a center point of circular rotating structure 106, each element base 104 has a diameter Dn. Thus, a plurality of diameters D1, D2, . . . Dn-1, and Dn, where n is the number of the element bases 104, are shown in FIG. 4C.

FIG. 4D illustrates a top-view of display system 400. The concentric circles representing moving directions of individual element bases 104. Each diameter D1, D2, . . . Dn-1, Dn represents a layer of 2D display, and the n number of layers of 2D displays are overlapped along the z-axis to form the 3D display. Further, a total of four 3D display elements 402 are included in display system 400.

Alternatively, a single element base may be used. A separate moving mechanism (not shown) may be provided to couple the single element base and the circular rotating structure 106 such that the single element base may be configured to move along the z-axis by the separate moving mechanism while moving around the x-axis by the circular rotating structure 106. Because of the persistence of version, a 3D image may also be displayed similarly by dynamic pixels in the x-axis direction as well as in the z-axis direction. Further, alternatively, the single column of the plurality of light-emitting elements of the element base 104 may be simulated by a single light-emitting element moving along the y-axis direction. That is, dynamic pixels may be used instead of static pixels under the control of a controller.

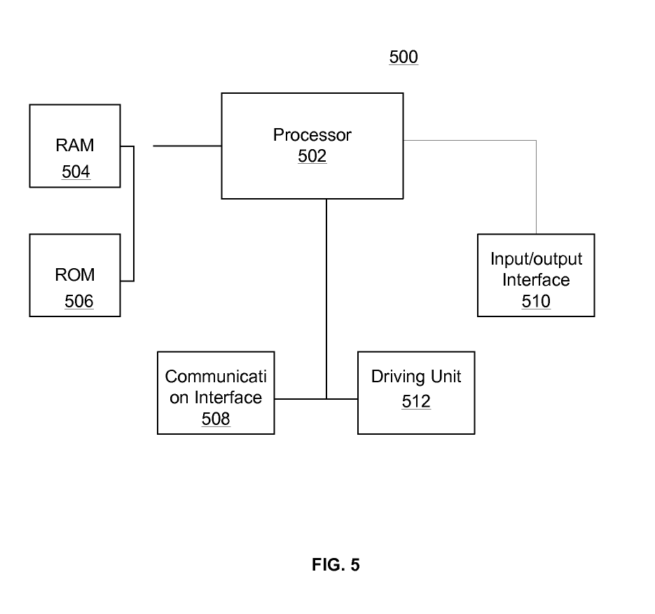

FIG. 5 illustrates an exemplary controller 500 used in the various display systems (e.g., display system 100 and display system 400) for controlling timing, position, and display of pixels in the display systems and/or operations of display systems. As shown in FIG. 5, controller 500 may include a processor 502, a random access memory (RAM) unit 504, a read-only memory (ROM) unit 506, a communication interface 508, an input/output interface unit 510, and a driving unit 512. Other components may be added and certain devices may be removed without departing from the principles of the disclosed embodiments.

Processor 502 may include any appropriate type of general purpose microprocessor, digital signal processor or microcontroller, and application specific integrated circuit (ASIC). Processor 502 may execute sequences of computer program instructions to perform various processes associated with various display systems. The computer program instructions may be loaded into RAM 504 for execution by processor 502 from read-only memory 506.

Communication interface 508 may provide communication connections such that the display systems may be accessed remotely and/or communicate with other systems through computer networks or other communication networks via various communication protocols, such as transmission control protocol/internet protocol (TCP/IP), hyper text transfer protocol (HTTP), etc.

Input/output interface 510 may be provided for users to input information into the display systems or for the users to receive information from the display systems. For example, input/output interface 510 may include any appropriate input device, such as a remote control, a keyboard, a mouse, an electronic tablet, voice communication devices, or any other optical or wireless input devices. Further, driving unit 512 may include any appropriate driving circuitry to drive various devices, such as light-emitting elements 102 and/or other display circuitry.

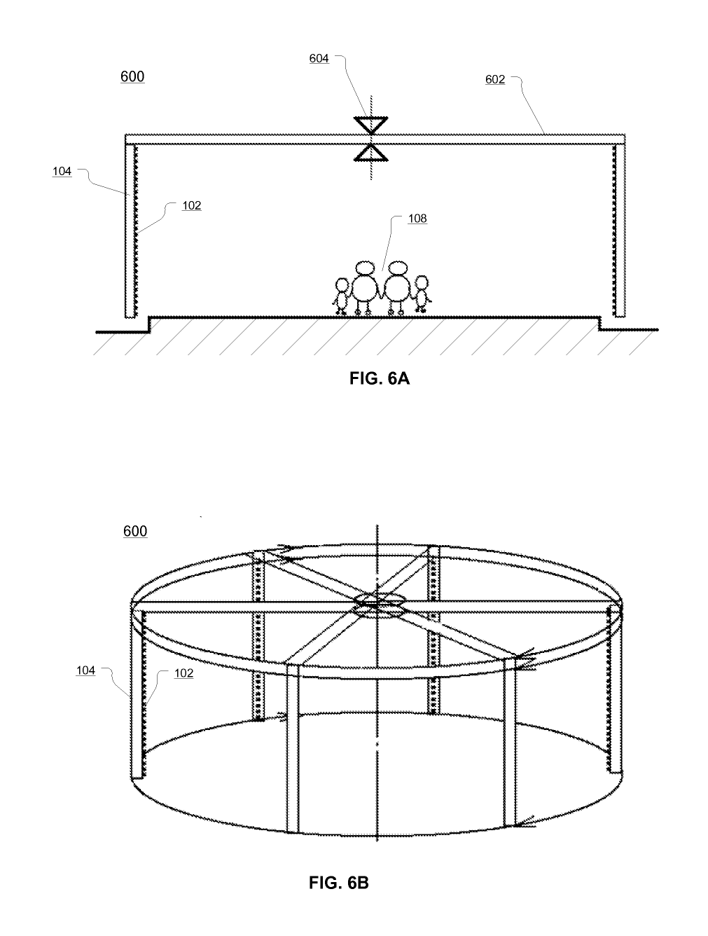

FIGS. 6A and 6B illustrate another exemplary display system 600 consistent with the disclosed embodiments. As shown in FIG. 6A, similar to display system 100, display system 600 includes a plurality of light-emitting elements 102, element base 104, and viewer(s) or view area 108. Individual light-emitting elements 102 may be controlled to emit light at a particular time and location while rotating with element base 104 so as to form a 2D circular display. However, unlike display system 100, display system 600 includes a circular rotating structure 602 and a shaft 604.

The circular rotating structure 602 may be rotated based on shaft 604, and the element base 104 are suspended from the circular rotating structure 602 (i.e., the top end of the element base 104 is connected with the bottom of circular rotating structure 602). Other devices may also be included. For example, display system 600 may include a power source (not shown) for light-emitting elements 102, and may also include a driving mechanism (e.g., driving unit 512) for driving circular rotating structure 602. In addition, display system 100 may include a controller (e.g., controller 500) for controlling the various devices and/or display system 600. FIG. 6B shows multiple element bases 104 containing light-emitting elements 102.

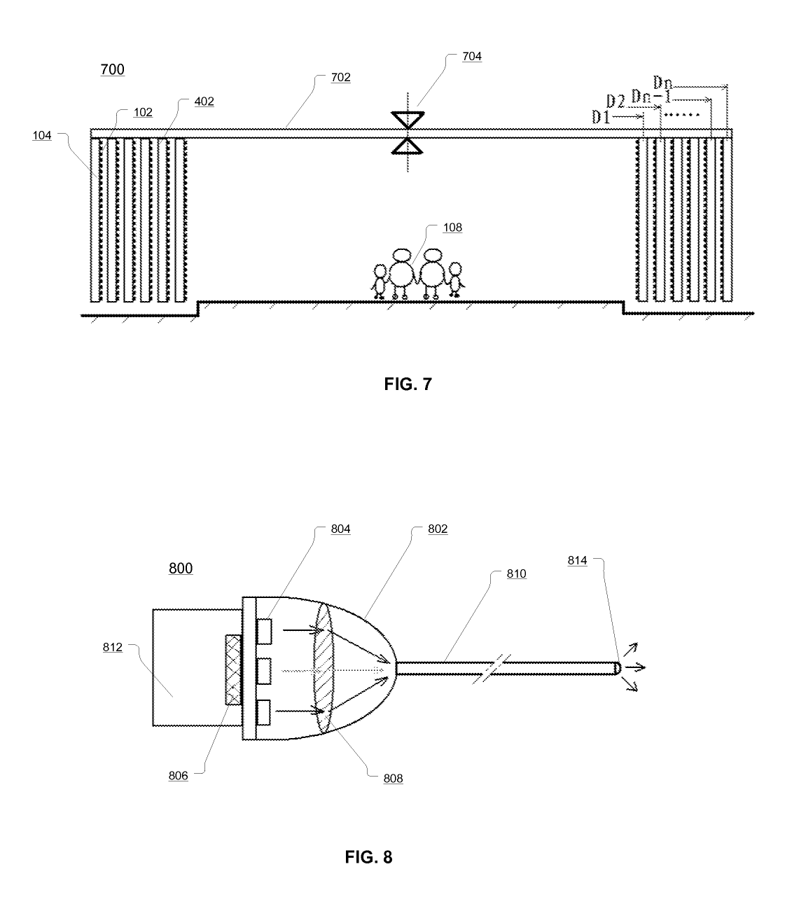

Similarly, FIG. 7 illustrates an exemplary 3D display system 700 using a different rotating mechanism. As shown in FIG. 7, similar to 3D display system 400, display system 700 includes series of element bases 104, and each element base 104 includes a plurality of light-emitting elements 102 such that an array of light-emitting elements 102 is formed. This array of light-emitting elements 102 is also referred to as 3D display element 402. Further, display system 700 includes a circular rotating structure 702, a shaft 704, and viewer(s) or view area 108. Circular rotating structure 702 may be rotated based on shaft 704 such that 3D display element 402 can rotated to form a circular 3D display.

Other devices may also be included in display system 700. For example, display system 700 may include a power source (not shown) for light-emitting elements 102, and may also include a driving mechanism (e.g., driving unit 512) for driving circular rotating structure 702. In addition, display system 700 may include a controller (e.g., controller 500) for controlling the various devices and/or display system 600. Further, multiple 3D display elements 402 may be included.

Further, in the various display systems described above, light-emitting element 102 may include any appropriate light source. For example, light-emitting element 102 may include a single full-color light-emitting-diode (LED) or multiple combined color LEDs (e.g., R, G, B LEDs). Further, to reduce the size of pixels to improve resolution while enhancing the brightness of the pixels, light-emitting element 102 may include a fiber optic light system 800.

As shown in FIG. 8, fiber optic light system 800 may include a light concentrator 802, an optical fiber 810, a driving circuit 806, a connector 812, and a pixel 814. Light concentrator 802 may be used to provide light for the optical fiber 810 and may further include light sources 804 and a light condenser 808. Certain components may be omitted and other components may be added.

Light sources 804 may include any appropriate light sources used for display. For example, light sources 804 may include color LEDs, such as a red LED, a green LED, and a blue LED so as to form a full color display. Or light sources 804 may also include full color LEDs. Light condenser 808 may include any appropriate device such as a lens for focusing the light from the light sources 804 such that the focused light is coupled into optical fiber 810 for transmission.

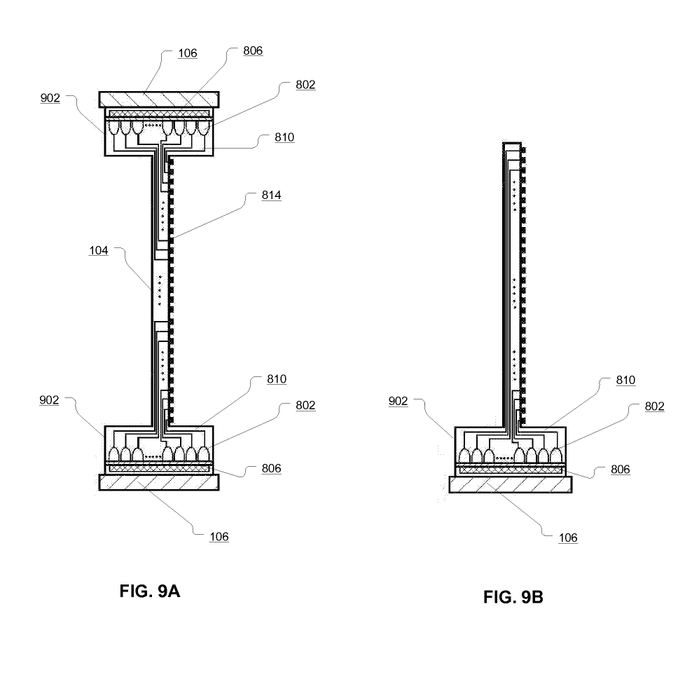

Driving circuit 806 may include any appropriate circuit for driving the light sources 804 under the control of, for example, controller 500 via the driving unit 512. Thus, the pixel 814 may be controlled to be turned on and off and/or to emit light with different color and/or strength when moving in a certain direction (e.g., x-axis). Further, connector 812 may include any material or device for connecting fiber optic light system 800 to a base. FIGS. 9A and 9B illustrate configurations of an exemplary element base 900 integrating fiber optic light system 800.

As shown in FIG. 9A, fiber optic light system 800 is integrated into element base 104. Element base 104 may have a base 902 on each end for housing a plurality of light collectors 802, optic fibers 810, and driving circuitry 806 for the plurality of light collectors 802. A plurality of pixels 814 are mounted on element base 104 to form a column of pixels 814 on the surface of element base 104 (i.e., light-emitting elements 102). Further, each base 902 is physically coupled to circular rotating structure 106 such that the column of pixels 814 can be rotated and controlled to form a circular cylindrical 3D display.

FIG. 9B shows a simplified version of FIG. 9A. As shown in FIG. 9B, only one end of element base 104 has a base 902 for housing a plurality of light collectors 802, optic fibers 810, and driving circuitry 806 for the plurality of light collectors 802. A plurality of pixels 814 are mounted on element base 104 to form a column of pixels 814 on the surface of element base 104 (i.e., a column of light-emitting elements 102). Further, base 902 is physically coupled to circular rotating structure 106 such that the column of pixels 814 can be rotated and controlled to form a circular cylindrical 3D display.

Further, in both FIGS. 9A and 9B, because the number of pixels 814 may be large, fiber optic light system 800 and other components may be modularized such that fiber optic light system 800 and other components can be exchanged or replaced independently to ensure easy disassembly and easy maintenance.

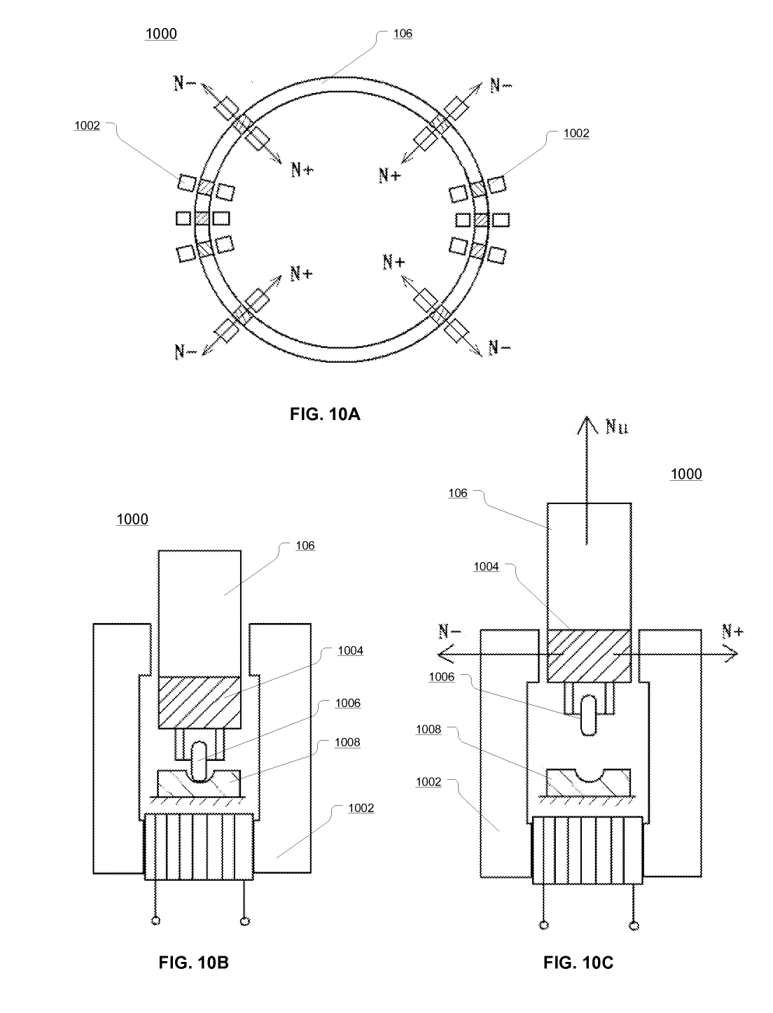

Circular rotating structure 106 may include any appropriate structure to rotate element bases 104 around a fixed track, such as a circular track. For example, circular rotating structure 106 may include a circular rotating structure based on magnetic levitation technology. FIG. 10A illustrates an exemplary circular magnetic levitation rotating structure 1000.

As shown in FIG. 10A, circular rotating structure 106 is mounted on a plurality of electromagnets 1002 symmetrically arranged in a ring structure, so that the radial magnetic field (N+ and N−) generated by the plurality electromagnets can be spread evenly to prevent circular rotating structure 106 from touching any side of the plurality of electromagnets. That is, circular rotating structure 106 can be kept in the middle of the space between two ends of any electromagnet 1002 and is also guided by the plurality of electromagnets 1002. In other words, the same electromagnets 1002 are configured to lift the circular rotating structure 106 and also to guide the circular rotating structure 106.

FIGS. 10B and 10C illustrate exemplary cross-section views of circular magnetic levitation rotating structure 1000. As shown in FIG. 10B, circular rotating structure 106 is also coupled to a plurality of magnetic conductors or permanent magnets 1004 or a single circular magnetic conductor or permanent magnet 1004. A plurality of landing wheels 1006 are also mounted on circular rotating structure 106 and/or the magnetic conductors 1004. Further, track 1008 is provided for the landing wheels 1006, and electromagnet 1002 is configured to couple the circular rotating structure 106 at predetermined position to achieve desired radial magnetic field.

In FIG. 10B, no electrical current is applied to electromagnet 1002. Thus, no radial magnetic field exists surround the circular rotating structure 106. Landing wheel 1006 stays in the track 1008 such that the weight of circular rotating structure 106 is carried by the landing wheel 1006 on track 1008.

However, as shown in FIG. 10C, an electrical current is applied to electromagnet 1002, and a radial magnetic field is created surround the circular rotating structure 106. Further, when the magnetic field passes through magnetic conductor 1004, this interaction generates three forces, a lifting force Nu, two attracting forces N+ and N−. When the lifting force Nu overcomes the total weight carried by landing wheel 1006, the landing wheel 1006 along with the circular rotating structure 106 and magnetic conductors 1004 are lifted such that landing wheel 1006 does not touch track 1008. To improve the Nu, a radical electromagnet may be used in addition to magnetic conductors 1004 on circular rotating structure 106. Further, N+ and N− are in opposite directions and applied evenly on circular rotating structure 106 to form a radial force field to keep the circular rotating structure 106 in the middle of the space between two ends of electromagnet 1002 and also to guide the circular rotating structure 106. Therefore, when a driving force is applied to the circular rotating structure 106, the circular rotating structure 106 can be rotated freely and circularly.

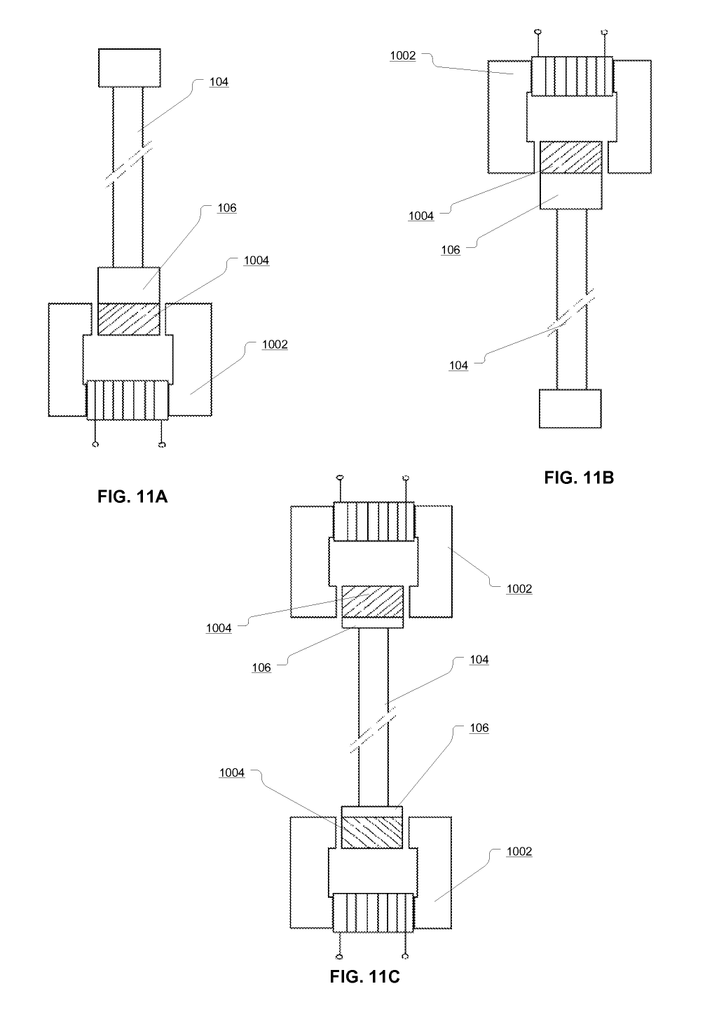

The circular magnetic levitation rotating structure 1000 can be integrated with element base 104 in different configurations. FIG. 11A shows a bottom-mounted configuration. That is, the lower end of element base 104 is coupled to circular rotating structure 106, which is mounted on and supported by magnetic conductors 1004 and electromagnets 1002. FIG. 11 B shows a top-mounted configuration. That is, the top end of element base 104 is coupled to circular rotating structure 106, which is suspended from and supported by magnetic conductors 1004 and electromagnets 1002.

Further, FIG. 11C shows a top-bottom-mounted configuration. That is, both the lower end and the top end of element base 104 are coupled to respective circular rotating structures 106. Two sets of structure arrangements of magnetic conductors 1004 and electromagnets 1002 are provided at top and at the bottom to couple and support the respective circular rotating structures 106.

In addition, in the various structures above, both electromagnets 1002 and magnet conductors 1004 can be made from permanent magnets such that the circular rotating structure 106 can always be lifted and the track 1008 and landing wheel 1006 may be omitted.

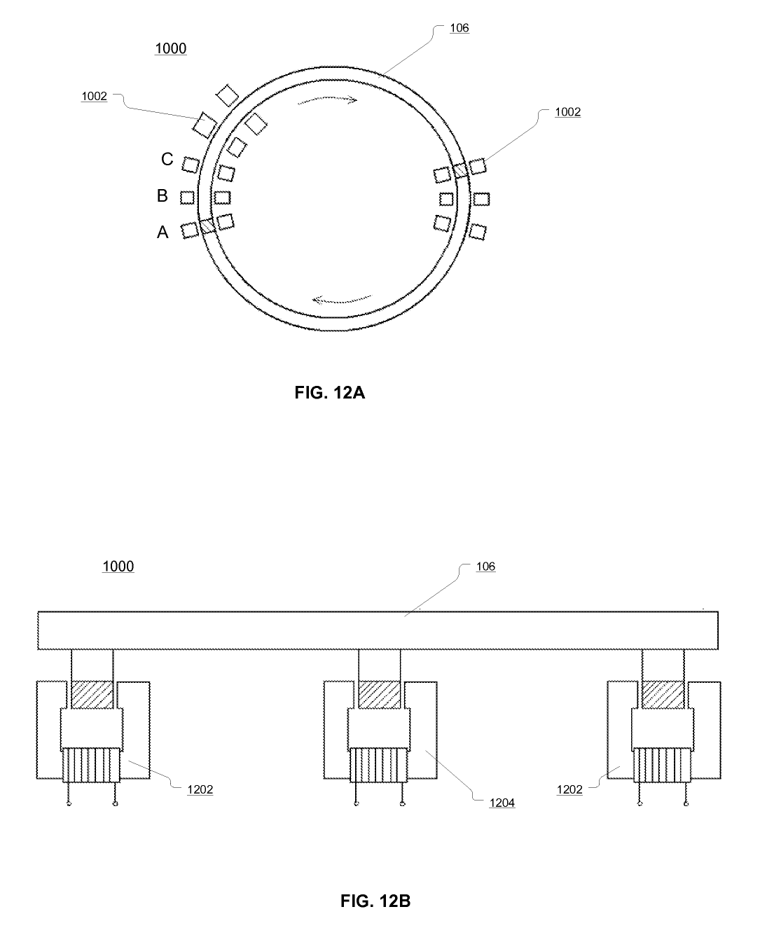

As previously explained, the circular rotating structure 106 may need to be driven during operation. FIG. 12A illustrates an exemplary driving configuration for circular magnetic levitation rotating structure 1000.

As shown in FIG. 12A, the plurality of electromagnets 1002 may be controlled to create a driving force. Using the three electromagnets A, B, and C for example, a controller (e.g., controller 500) may control the electrical current being applied to the electromagnets A, B, and C. First, the controller applies the electrical current to electromagnetic A. Then, the controller stops applying electrical current to electromagnet A, but applies the electrical current to electromagnet B. Thus, the magnetic field created by turning off the electromagnet A and turning on the electromagnet B (i.e., switching from electromagnet A to electromagnet B) generates a driving force to rotate the circular rotating structure 106 in a clockwise direction. Similarly, the controller stops applying the electrical current to electromagnet B, but applies the electrical current to electromagnet C. Thus, the driving force can be maintained by continuing to switch electromagnets in a circular fashion. In other words, in FIG. 12A, driving electromagnets and lifting electromagnets are the same.

FIG. 12B shows another exemplary driving configuration for circular magnetic levitation rotating structure 1000. In FIG. 12B, different electromagnets are used for driving and for lifting. As shown in FIG. 12B, the plurality of electromagnets 1202 (i.e., electromagnets 1002) may be controlled to create the lifting force Nu. However, one or more separate electromagnet 1204 is used just for driving the circular rotating structure 106. Other configurations may also be used.

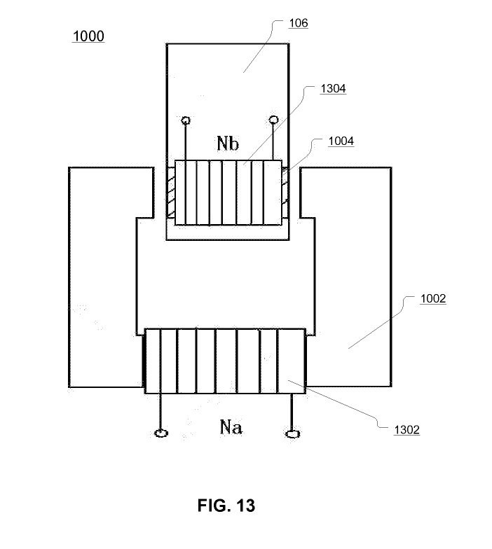

Because light-emitting elements 102 need power sources during operation to emit light, certain power sources (not shown) are provided in the above disclosed various display systems. Alternatively, as shown in FIG. 13, circular magnetic levitation rotating structure 1000 may be configured to provide an electrical power source to light-emitting elements 102 and/or other components.

More specifically, a primary coil Na is placed on electromagnet 1002, and a secondary coil Nb is placed on circular rotating structure 106 or magnetic conductor 1004. Because the secondary coil Nb is rotating along with circular rotating structure 106, when an electrical current is provided in the primary coil Na, either an AC current or DC current, the secondary coil Nb can generate an induced electrical current to be provided to light-emitting elements 102 as a power source after certain processing. Thus, the power source can be provided without wire connections from external sources.

The various display systems described above use a cylindrical 2D display or a cylindrical 3D display for illustrative purposes. In practice, any appropriate geometric shapes may be used for the 2D displays and/or 3D displays, based on the principles of the disclosed embodiments. The followings describe various applicable display formations and shapes.

As shown in FIG. 14A, a column of light-emitting elements 102 is rotating within a plane to form a 2D display in a shape of a hollow circular disk. Similarly, as shown in FIG. 14B, a 3D display in a shape of a hollow cylinder is formed by rotating an array of light-emitting elements 102 in a circular direction.

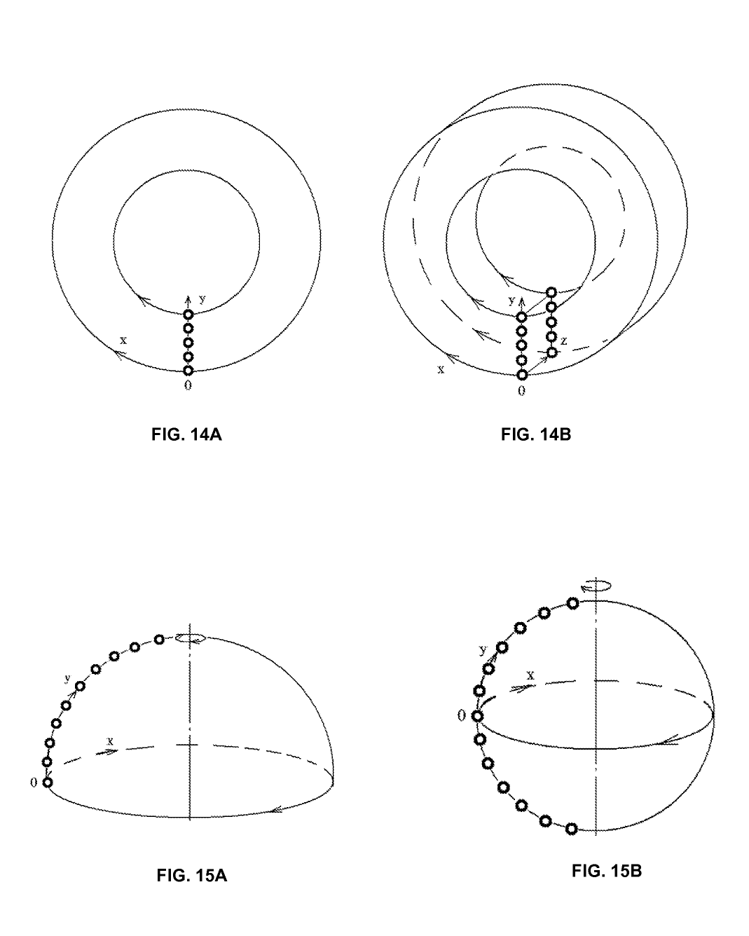

As shown in FIG. 15A, a plurality of light-emitting elements 102 are arranged in an arc (e.g., about ¼ of a circle) and are rotated in a circular direction so as to form a semi-sphere 2D display. Similarly, as shown in FIG. 15B, a sphere 2D display is formed. For the sake of simplicity, light-emitting elements 102 are omitted in following figures, assuming that light-emitting elements 102 emit lights toward viewers.

FIG. 16A illustrates a cylindrical 2D display and viewers are arranged to view the display from inside the cylinder, which may be called an inner display. Similarly, when the viewers are arranged to view a display from outside of a circular, spherical or other shapes of display, it may be called an outer display. When the viewers are arranged to view a display from top of the display, it may be called a ground display; and when the viewers are arranged to view from bottom of the display, it may be called a sky display. Other configurations may also be used. Further, FIG. 16B illustrates a cylindrical 3D display, which is also configured as an inner display.

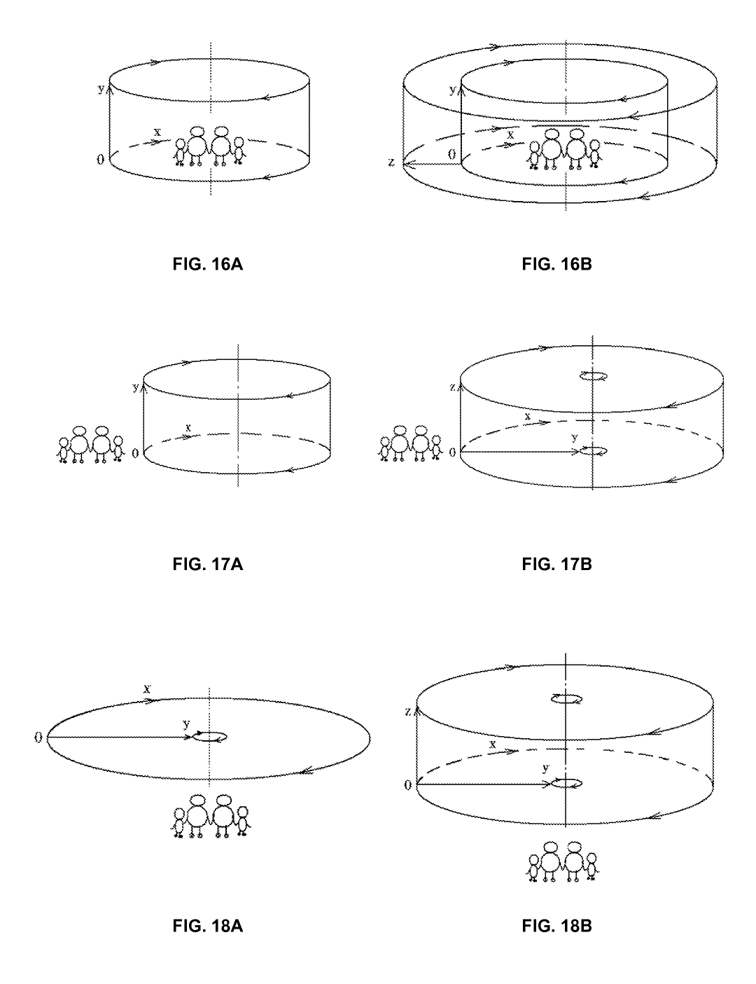

FIG. 17A illustrates a cylindrical 2D display being configured as an outer display, and FIG. 17B illustrates a cylindrical 3D display being configured as an outer display.

FIG. 18A illustrates a circle 2D display being configured as a sky display, and FIG. 18B illustrates a circle 3D display being configured as a sky display.

FIG. 19A illustrates a circle 2D display being configured as a ground display, and FIG. 19B illustrates a circle 3D display being configured as a ground display.

FIG. 20A illustrates a circle 2D display being configured as a vertical display (i.e., the viewers are arranged to view the vertically displayed image of the circle 2D display), and FIG. 20B illustrates a circle 3D display being configured as a vertical display.

FIG. 21A illustrates a semi-sphere 2D display being configured as an inner display, and FIG. 21B illustrates a semi-sphere 3D display being configured as an inner display.

FIG. 22A illustrates an upside-down semi-sphere 2D display being configured as an outer display, and FIG. 22B illustrates an upside-down semi-sphere 3D display being configured as an outer display.

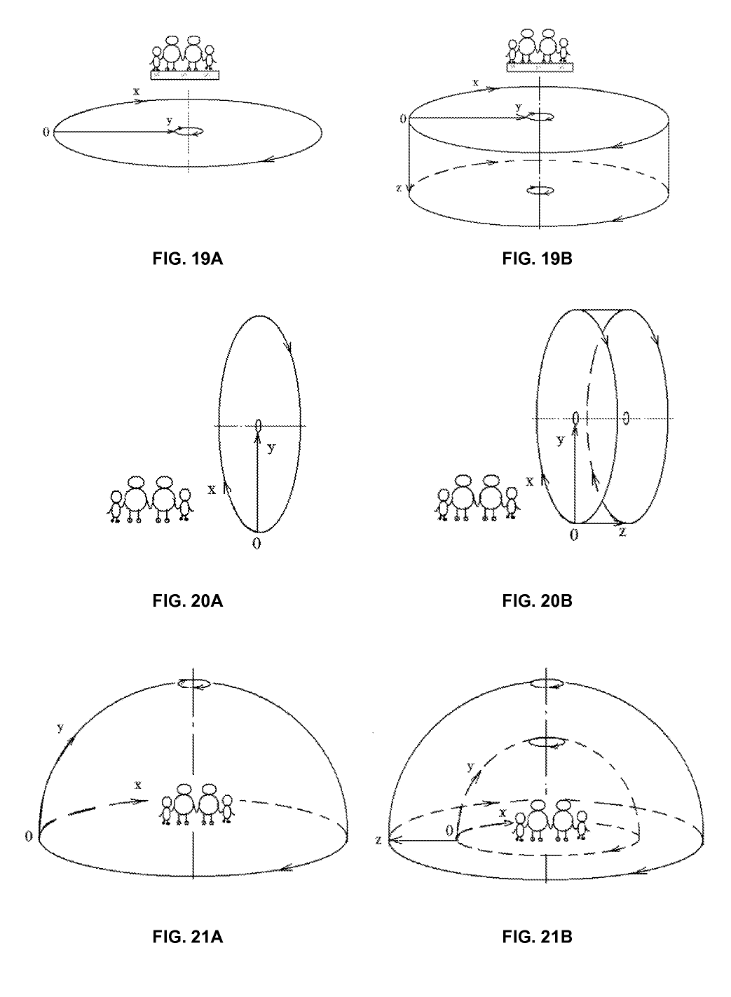

FIG. 23A illustrates an upside-down semi-sphere 2D display being configured as an inner display, and FIG. 23B illustrates an upside-down semi-sphere 3D display being configured as an inner display.

FIG. 24A illustrates a semi-sphere 2D display being configured as a ground display, and FIG. 24B illustrates a semi-sphere 3D display being configured as a ground display.

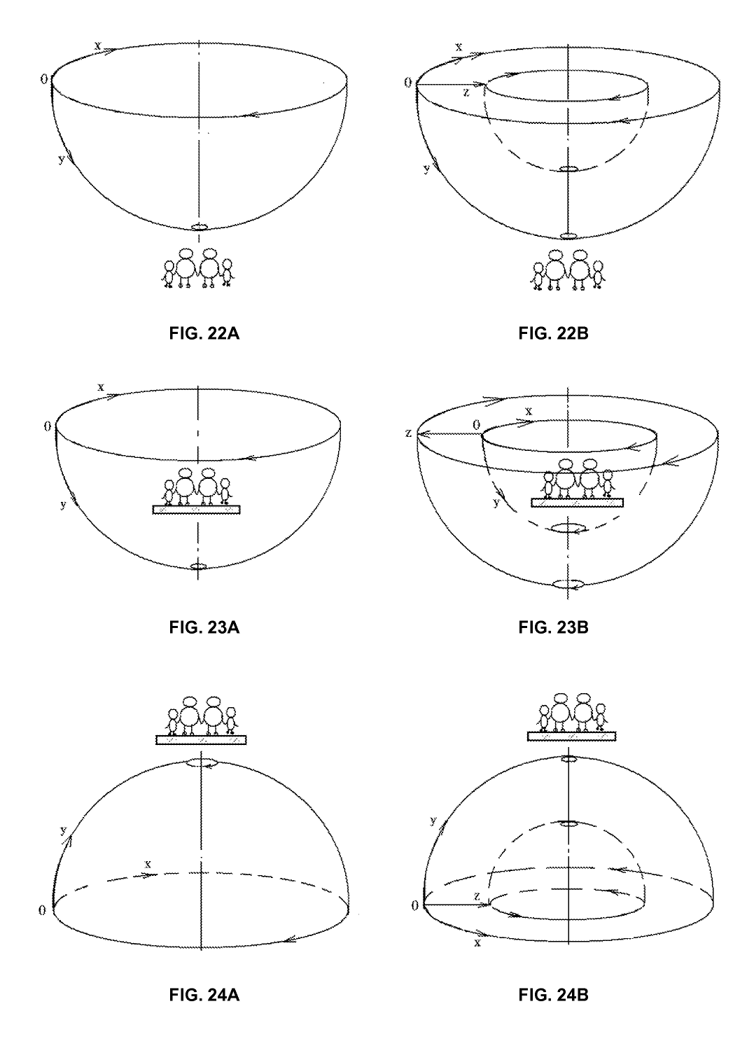

FIG. 25A illustrates a semi-sphere ring 2D display being configured as an inner display, and FIG. 25B illustrates a semi-sphere ring 3D display being configured as an inner display.

FIG. 26A illustrates a semi-sphere ring 2D display being configured as a ground display, and FIG. 26B illustrates a semi-sphere ring 3D display being configured as a ground display.

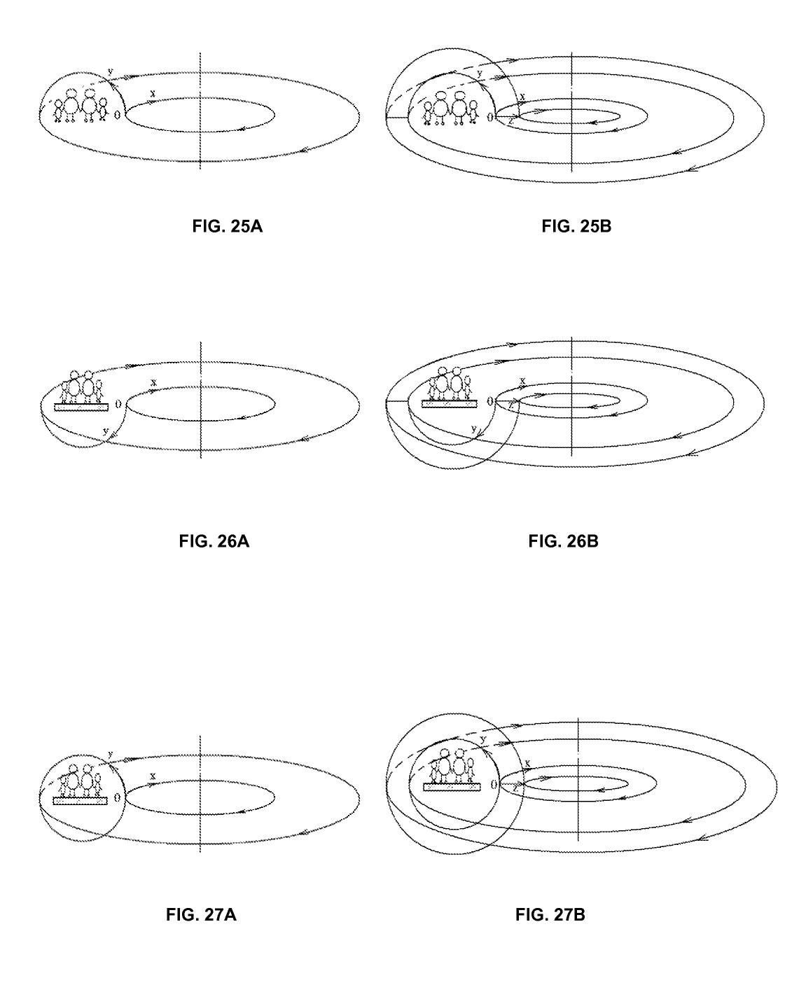

FIG. 27A illustrates a sphere ring 2D display being configured as an inner display, and FIG. 27B illustrates a sphere ring 3D display being configured as an inner display.

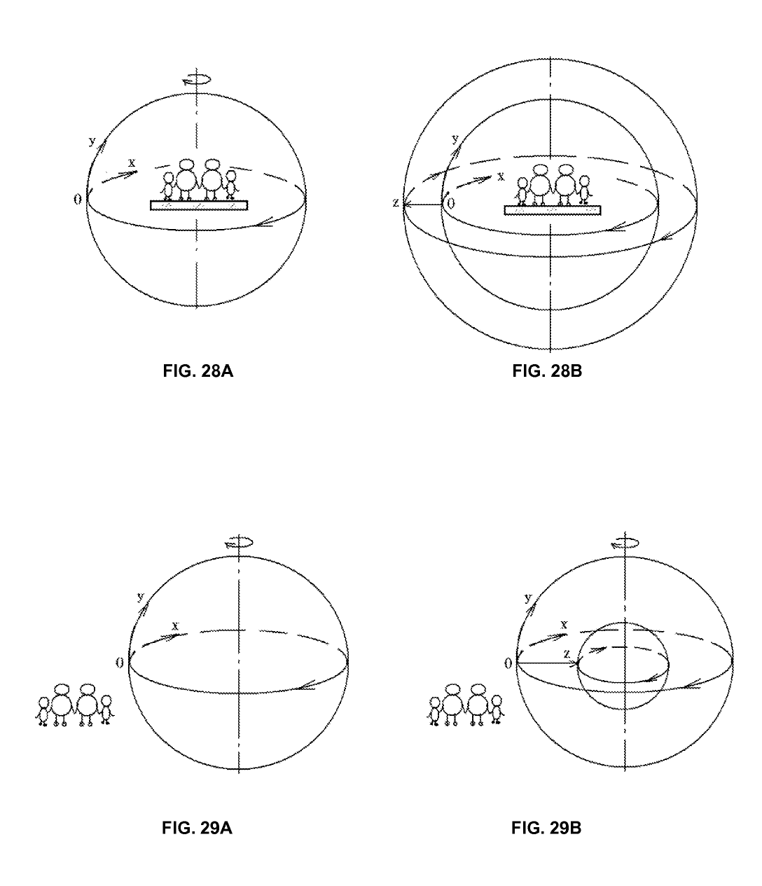

FIG. 28A illustrates a sphere 2D display being configured as an inner display, and FIG. 28B illustrates a sphere 3D display being configured as an inner display.

FIG. 29A illustrates a sphere 2D display being configured as an outer display, and FIG. 29B illustrates a sphere 3D display being configured as an outer display.

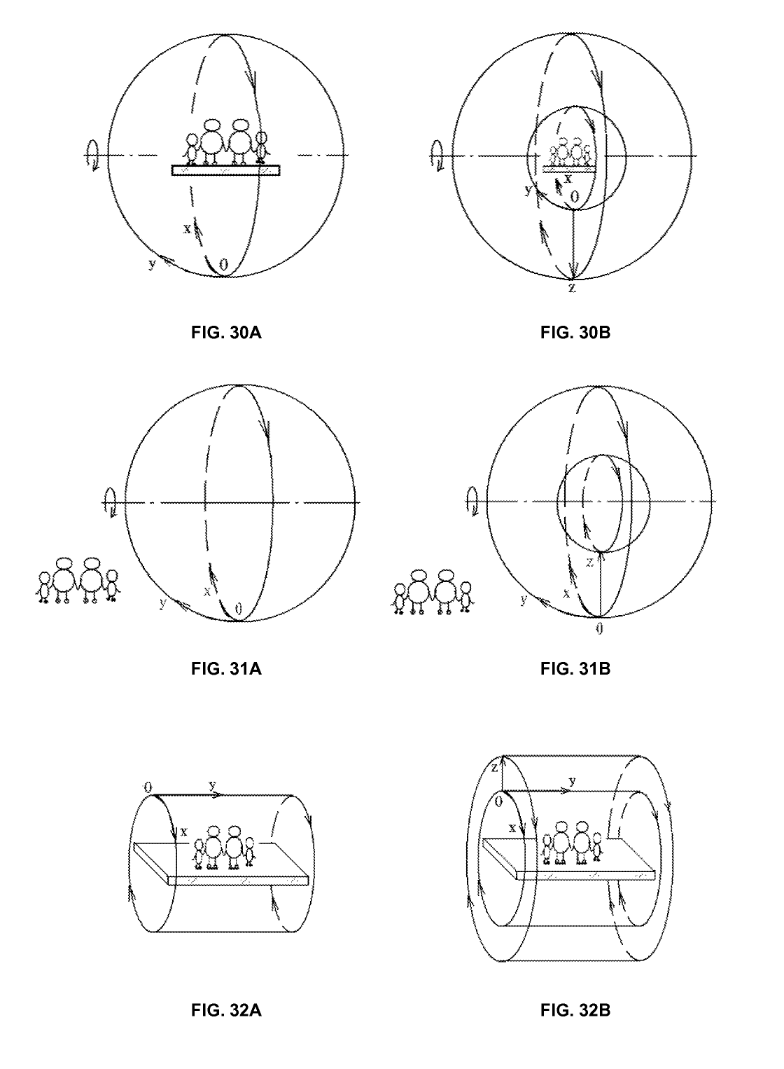

FIG. 30A illustrates a sphere 2D display being configured as an inner display, and the sphere is formed by rotating a semi-circle column of light-emitting elements 102 around a horizontal axis. Similarly, FIG. 30B illustrates a sphere 3D display formed by rotating horizontally and being configured as an inner display.

FIG. 31A illustrates a sphere 2D display formed by rotating horizontally and being configured as an outer display, and FIG. 31B illustrates a sphere 3D display formed by rotating horizontally and being configured as an outer display.

FIG. 32A illustrates a cylindrical 2D display formed by rotating horizontally and being configured as an inner display, and FIG. 32B illustrates a cylindrical 3D display formed by rotating horizontally and being configured as an inner display.

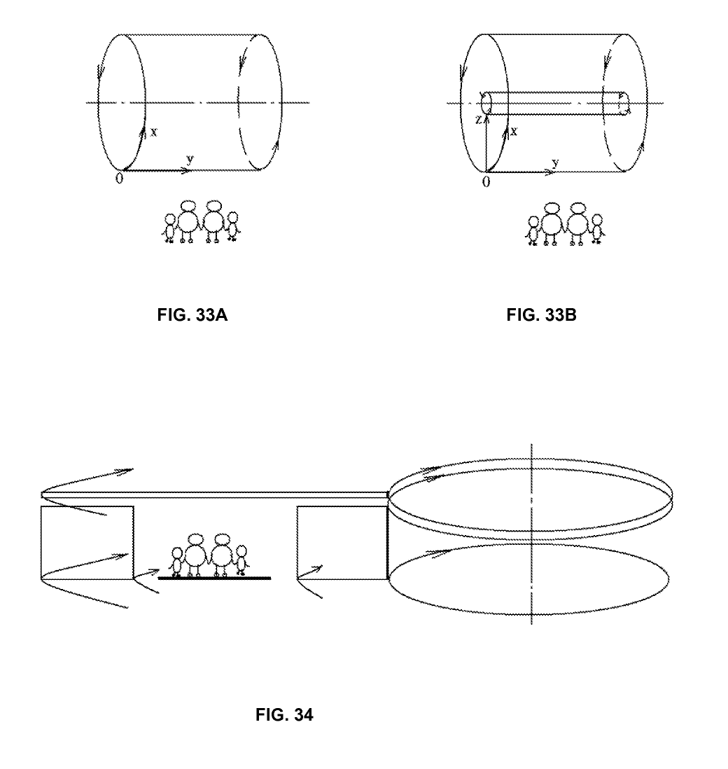

FIG. 33A illustrates a cylindrical 2D display formed by rotating horizontally and being configured as an outer display, and FIG. 33B illustrates a cylindrical 3D display formed by rotating horizontally and being configured as an outer display.

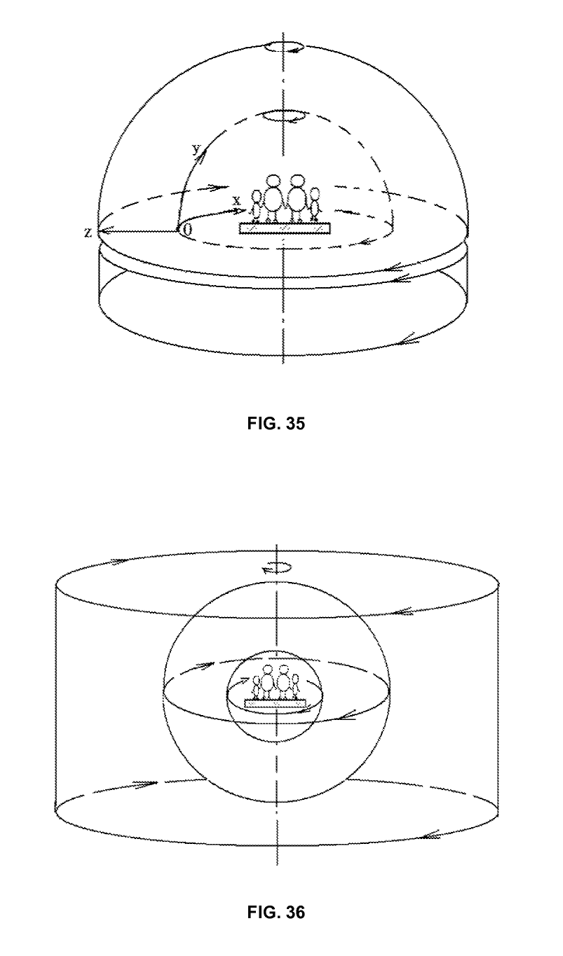

In addition, various displays can be combined together to form a multi-display system. For example, FIG. 34 illustrates a combination of a cylindrical 3D display configured as an inner display, a cylindrical 3D display configured as an outer display, and a circle 2D display configured as a sky display. FIG. 35 illustrates a combination of a semi-sphere 3D display configured as an inner display and a cylindrical 3D display configured as a ground display. FIG. 36 illustrates a combination of a sphere 3D display configured as an inner display and a cylindrical 2D display also configured as an inner display. Other combinations may also be used.

By using the disclosed systems and methods, various alternative and advantageous display applications can be provided. Particularly, the systems for 3D images can be used not only in movie display, but also in recreational space and marine equipment to simulate the space and ocean and various types of training equipment and 3D games.

Other embodiments of the disclosure will be apparent to those skilled in the art from consideration of the specification and practice of the disclosure herein. It is intended that the specification and examples be considered as exemplary only, with the scope being indicated by the following claims.

What is claimed is:

1. A three-dimensional (3D) display system, comprising:
at least one 3D display element containing a series of element bases, each element base including a plurality of light-emitting elements in a predetermined arrangement;
a moving mechanism coupled to the 3D display element for causing the 3D display element to move along a predetermined direction; and
a controller configured to control respective light-emitting conditions of the plurality of light-emitting elements contained in each element base, when each element base is moving in the predetermined direction, to create dynamic pixels based on persistence of vision so as to form a layer of 2D display,
wherein the layers of 2D display corresponding to the series of element bases overlap together to form a 3D display.

2. The 3D display system according to claim 1, wherein:
the predetermined direction is one of a straight line direction, a circular direction, and a curve direction.

3. The 3D display system according to claim 1, wherein:
the predetermined arrangement includes at least one column shaped as one of a line, a curve, and a combination thereof such that the layer of 2D display is one of a plane, a cylinder surface, a half-sphere surface, and a sphere surface.

4. The 3D display system according to claim 1, wherein:
the moving mechanism is a circular rotating structure capable of rotating around a center of the circular rotating structure;
the plurality of light-emitting elements are arranged as at least one column; and
each element base is rotating around the center of the circular rotating structure to form the layer of 2D display.

5. The 3D display system according to claim 1, wherein:
a total number of the layers of 2D display represents a scene depth of the 3D display.

6. The 3D display system according to claim 4, wherein:
the 3D display is separated into multiple sectors each displaying a separate picture.

7. The 3D display system according to claim 1, wherein:
a light-emitting element includes a full color light-emitting-diode (LED).

8. The 3D display system according to claim 1, wherein:
a light-emitting element includes a combination of multiple color LEDs.

9. The 3D display system according to claim 1, wherein:
a light-emitting element includes a fiber optic light system, the fiber optic light system including:
an optical fiber;
a light concentrator configured to provide light coupling into the optical fiber; and
a pixel coupled to the optical fiber to receive the light transmitted through the optical fiber.

10. The 3D display system according to claim 9, the fiber optic light system further including:
a connector configured to connect the light concentrator to an element base containing the light-emitting element.

11. The 3D display system according to claim 10, wherein:
the light concentrator includes a plurality of LEDs as a light source to emit light and a lens for focusing the light from the LEDs into the optical fiber.

12. The 3D display system according to claim 11, wherein:
the light concentrator is mounted on the moving mechanism and the pixel is mounted on one of the element bases as a light-emitting element.

13. The 3D display system according to claim 4, wherein:
the circular rotating structure includes a plurality of magnetic conductors and is mounted on a plurality of magnets symmetrically arranged in a ring structure to achieve a circular magnetic levitation rotating structure.

14. The 3D display system according to claim 13, further including:
a track; and
a plurality of landing wheels coupled to the track for carrying weight of the circular rotating structure.

15. The 3D display system according to claim 13, wherein:
each element base is coupled to the circular rotating structure in one of a top-mounted configuration, a bottom-mounted configuration, and a top-bottom-mounted configuration.

16. The 3D display system according to claim 13, wherein:
the circular rotating structure is driven by switching on and off neighboring magnets in a predetermined sequence.

17. The 3D display system according to claim 13, wherein:
at least one separate magnet configured to drive the circular rotating structure.

18. The 3D display system according to claim 13, wherein:
a primary coil is arranged on the magnet coinciding with the driving magnet; and
a secondary coil is arranged on the circular rotating structure to, when moving against the primary coil, generate induced electrical current to be provided to the light-emitting elements.

19. The 3D display system according to claim 1, wherein:
a viewer area configured for at least one viewer to view the 3D display.

20. The 3D display system according to claim 19, wherein:
the 3D display is a cylindrical 3D display and the view area is configured inside the cylindrical 3D display or outside the cylindrical 3D display.

21. The 3D display system according to claim 19, wherein:
the 3D display is a semi-sphere 3D display and the view area is configured inside the semi-sphere 3D display or outside the semi-sphere 3D display.

22. The 3D display system according to claim 19, wherein:
the 3D display is a semi-sphere ring 3D display and the view area is configured inside the semi-sphere ring 3D display.

23. The 3D display system according to claim 19, wherein:
the 3D display is a semi-sphere ring 3D display and the view area is configured at the top of the semi-sphere ring 3D display.

24. The 3D display system according to claim 19, wherein:
the 3D display is a sphere 3D display and the view area is configured inside the sphere 3D display or outside the sphere 3D display.

25. The 3D display system according to claim 19, wherein:
the 3D display is combination of a plurality of different-geometrically-shaped 3D displays and 2D displays.

26. The 3D display system according to claim 25, wherein:
the 3D display is combination of a first cylindrical 3D display, a second cylindrical 3D display, and a circle 2D display, and the view area is configured inside the first cylindrical 3D display, outside the second cylindrical 3D display, and at the bottom of the circle 2D display.

27. The 3D display system according to claim 25, wherein:
the 3D display is combination of a semi-sphere 3D display and a cylindrical 3D display, and the view area is configured inside the semi-sphere 3D display and at the top of the cylindrical 3D display.

28. The 3D display system according to claim 25, wherein:
the 3D display is combination of a sphere 3D display and a cylindrical 2D display, and the view area is configured inside the sphere 3D display and inside the cylindrical 2D display.

29. The 3D display system according to claim 1, wherein:
the series of element bases are simulated by a single element base moving in a z-axis direction using a separate moving mechanism and controlled by the controller.

30. The 3D display system according to claim 1, wherein:
the plurality of light-emitting elements of an element base is simulated by a single light-emitting element moving in a y-axis direction controlled by the controller.
